(19) United States
(12) Patent Application Publication
(10) Pub. No.: US 2024/0219987 A1
(43) Pub. Date: Jul. 4, 2024

(54) MOVABLE MINING MACHINES WITH DYNAMICALLY ADJUSTABLE COMPUTING POWER

(71) Applicant: Golnfinite FinTech Ltd., New Taipei City (TW)

(72) Inventor: YUAN-CHENG HSU, New Taipei City (TW)

(21) Appl. No.: 18/126,495

(22) Filed: Mar. 27, 2023

(30) Foreign Application Priority Data
Dec. 29, 2022 (TW) 111150751

(51) Int. Cl. G06F 1/3203; G06F 1/20

(52) U.S. Cl. CPC G06F 1/3203; G06F 1/206

(57) ABSTRACT

A movable mining machine with dynamically adjustable computing power includes a computing unit having a plurality of chips connected in parallel, for calculating hash values of a block; a power unit capable of adjusting voltages sent to the plurality of chips; a sensing unit for sensing temperatures of the plurality of chips; a control unit capable of controlling the plurality of chips to calculate the hash values of the block on division of labor; a communication unit capable of transmitting the hash values of the block and a verification result via a network; wherein when the hash value calculated by any one of the plurality chips is verified as correct, the control unit controls the plurality of chips to stop calculating the hash values until the communication unit receives next block. The mining machine of the present invention can optimize the power consumption and computing performance of the chips.

### CROSS-REFERENCE TO RELATED APPLICATION

This application claims the priority of Taiwanese patent application No. 111150751, filed on Dec. 29, 2022, which is incorporated herewith by reference.

### BACKGROUND OF THE INVENTION

### 1. Field of the Invention

The present invention relates generally to a mining machine, and more particularly, to a movable mining machine with dynamically adjustable computing power.

### 2. The Prior Arts

Virtual currency mining is a process of packing virtual currency transaction records into blocks and then generating hash values for the blocks. This process is carried out by so-called “miners”, who use computers (i.e. mining machines) to preemptively calculate the hash value of the next block containing new transactions, which is commonly known as mining.

To mine virtual currency, a miner need to operate a mining node that collects transaction records and packs them into blocks. This mining node also needs to have enough computing power so that the miner can have the opportunity to be the first to calculate the hash value that meets the requirements. As such, a mining node is expensive to run, and requires a powerful computer device and a lot of electricity to execute.

At present, mining mainly utilizes graphics cards. As the mining graphics cards are fully loaded for a long time, the power consumption may be relatively high, so is the electricity bill. Mining is often considered a competition of performance and equipment. The computing power of a mining machine composed of many graphics cards can still outperform most single graphics cards, but how to achieve the most efficient and maximum computing power of the combined mining machine is still a problem to be solved and improved.

### SUMMARY OF THE INVENTION

A primary objective of the present invention is to provide a mining machine with dynamically adjustable computing power to address the aforementioned issues.

In order to achieve the above objective, the present invention provides a mining machine with dynamically adjustable computing power, including a computing unit, a power unit, a sensing unit, a control unit, and a communication unit; wherein the computing unit comprising a plurality of chips, connected in parallel to calculate a hash value of a block; the power unit comprising a voltage regulator, to provide power to the computing unit and adjust the voltage sent to the plurality of chips; the sensing unit comprising a temperature sensor, connected to the computing unit, to sense temperatures of the plurality of chips; the control unit connecting the computing unit, the power unit, and the sensing unit to control the plurality of chips to calculate the hash value of the block, and control the operation frequency of the plurality of chips according to a target computing power and temperature range of the computing unit; the communication unit, connected to the control unit, for transmitting the hash value of the block and a verification result of the hash value through the network; when the hash value calculated by any chip in the plurality of chips being verified to be correct, the control unit controlling the plurality of chips to stop calculating the hash value of the block until the communication unit receiving a next block.

In a preferred embodiment, the target computing power is between 1 MH/s and 500 TH/s.

In a preferred embodiment, the control unit controls the operating frequency of the plurality of chips to be between 100 MHz and 2 GHz.

In a preferred embodiment, when the computing power of the computing unit is lower than the target computing power, the control unit controls the power unit to increase the voltages of the chips with a lower computing frequency among the plurality of chips, so as to increase the computing power of the computing unit.

In a preferred embodiment, when the hash value calculated by the computing unit reaches the target computing power, and the temperatures of the plurality of chips exceed an upper limit of the temperature range, the control unit controls the power unit to provide power to the plurality of chips in a time-sharing manner, so that the plurality of chips are time-sharing in calculating the hash value of the block.

In a preferred embodiment, the communication unit comprises a wired module and/or a wireless module, wherein the wired module is a universal serial bus (USB) that can be connected to a computer device, and the wireless module is a Global System for Mobile Communications (GSM), Wi-Fi, or Bluetooth.

In a preferred embodiment, the movable mining machine with dynamically adjustable computing power further comprises a fan connected to the control unit and the power unit, able to rotate to generate airflow to reduce the temperature of the computing unit.

In a preferred embodiment, when the temperature of the computing unit is lower than a lower limit of the temperature range, the control unit controls the fan to stop rotating; when the temperature of the computing unit is within the temperature range, the control unit adjusts the speed of the fan according to the temperature of the computing unit.

In a preferred embodiment, when the power of the power unit is insufficient, the control unit controls the power unit to reduce the power provided to the computing unit, or controls the power unit to provide power to different chips among the plurality of chips in a time-sharing manner.

In the movable mining machine with dynamically adjustable computing power of the present invention, the control unit intelligently regulates the computing frequency or division of labor among the plurality of chips and the output power of the power unit based on the hash value calculated by the computing unit, the target computing power, and the temperature range, so as to optimize the power consumption and computing performance of the chips.

The present invention will be apparent to those skilled in the art by reading the following detailed description of a preferred embodiment thereof, with reference to the attached drawings.

### BRIEF DESCRIPTION OF THE DRAWINGS

FIG. 1 is a block diagram of a movable mining machine with dynamically adjustable computing power according to an embodiment of the present invention;

FIG. 2 is a flowchart of the operation of a movable mining machine with dynamically adjustable computing power according to an embodiment of the present invention;

FIG. 3 is a flowchart of the operation of a movable mining machine with dynamically adjustable computing power according to another embodiment of the present invention;

FIG. 4 is a block diagram of a movable mining machine with dynamically adjustable computing power according to another embodiment of the present invention; and

FIG. 5 is an operation flowchart of a movable mining machine with dynamically adjustable computing power according to another embodiment of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

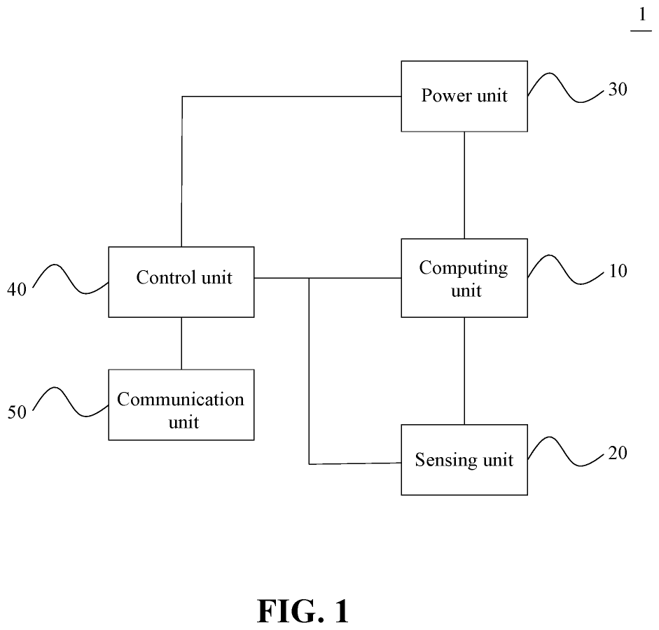

FIG. 1 is a block diagram of a movable mine machine with dynamically adjustable computing power according to the present invention. As shown in FIG. 1, the movable mine machine 1 with dynamically adjustable computing power includes a computing unit 10, a sensing unit 20, a power unit 30, a control unit 40, and a communication unit 50. The computing unit 10 is connected with the sensing unit 20, the power unit 30, and the control unit 40, respectively. The control unit 40 is also connected to the sensing unit 20, the power unit 30, and the communication unit 50 respectively.

Specifically, the computing unit 10 includes a plurality of chips, the chip is an application-specific integrated circuit (ASIC), and the plurality of chips are connected in parallel, and the main function of the computing unit 10 is based on the Hashcash algorithm, such as but not limited to Sha-256d, to calculate the hash value of a block and transmit the calculated hash value back to the control unit. A block can be transaction data for a single or different crypto currency, such as, Bitcoin, Ethereum.

Specifically, the chip in the computing unit 10 is required to adjust the impedance per grid unit when designing the circuit, wherein the error value is preferably less than 0.01%.

Specifically, the sensing unit 20 includes a temperature sensor capable of sensing the temperatures of the computing unit 10 and individual chips.

Specifically, the power unit 30 can be connected to an external power supply. The power unit 30 includes a voltage regulator, which provides power to the computing unit 10 and adjusts the voltage delivered to the plurality of chips. The power unit 30 provides a fixed voltage to the sensing unit 20 and the control unit 40, and the voltage regulator can adjust the voltage delivered to the individual chips. The voltage delivered to the chip by the power unit 30 is, for example but not limited to, 0.8 volts (V), 1.8V, 3.3V, 5V, or 12V.

Specifically, the control unit 40 which receives the computing unit 10 may be a microcontroller unit (MCU). The control unit 40 controls the computing frequency of the chip based on the hash rate (real-time computing power) calculated by the computing unit 10, the preset target computing power, and the temperature range.

Specifically, the communication unit 50 includes a wired module and/or a wireless module. The wired module is a universal serial bus (USB) that can be connected to a computer device, and integrates idle resources of the computer device, such as calculation program stored in the computer device, to perform operations, i.e., mining. The wireless module can be Global System for Mobile Communications (GSM), wireless network (Wi-Fi) or Bluetooth.

Specifically, the number of hash values calculated by the chip of the computing unit 10 per second is related to the computing power of the computing unit 10. The computing unit 10 transmits the calculated hash value to the control unit 40, and the control unit 10 can determine whether the computing power of the computing unit 10 reaches the target computing power. The target computing power is between 1×10⁶ hash value/second to 500×10¹² hash value/second (1 MH/s to 500 TH/s), for example, but not limited to, 1 MH/s-1 GH/s, 1 GH/s-500 GH/s, 500 GH/s-1 TH/s, 1-100 TH/s, 100-500 TH/s.

It is worth noting that the size of the movable mining machine 1 with dynamically adjustable computing power is suitable for users to connect to the mine for mining at any time and any place, at the dimensions in length: width: height as, for example but not limited to, 125 mm: 60 mm: 46 mm. In addition, as the movable mining machine 1 with dynamically adjustable computing power greatly reduces ineffective power consumption, the computing performance is improved. Compared to the 80-100 decibels generated by the operation of the existing mining machine, the movable mining machine 1 with dynamically adjustable computing power provided by the present invention only produces a sound of about 30 decibels during operation.

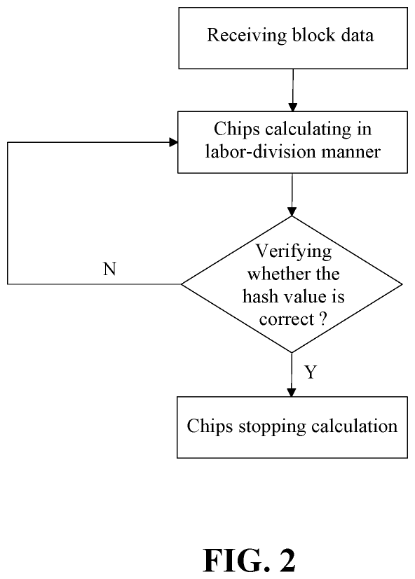

FIG. 2 is a flowchart of the operation of a movable mining machine 1 with dynamically adjustable computing power according to another embodiment of the present invention. As shown in FIG. 1 and FIG. 2, the communication unit 50 of the movable mining machine 1 with dynamically adjustable computing power receives a block data, and the control unit 40 controls the plurality of chips of the computing unit 10 to calculate the hash value of the block, for example, the value range is calculated by different chips. The control unit 40 transmits the hash values calculated by different chips to the mining field for verification through the communication unit 50, when the hash value calculated by any chip in the plurality of chips is verified as correct, the control unit 40 immediately controls the plurality of chips to stop calculating the hash value until the communication unit 50 receives a next block data.

During the calculation process of the existing mining machine, no matter whether the correct hash value has been obtained or not, all chips will not stop calculating. The ineffective calculations will not only increase power consumption, but will also continue to generate high temperatures, which will affect the computational efficiency performance of the chips. The movable mining machine 1 with dynamically adjustable computing power of the present invention controls the plurality of chips to calculate the hash value, which can accelerate the generation of the correct hash value. After the correct hash value is obtained, the plurality of chips is controlled to suspend the calculation, which significantly reduces ineffective power consumption and chip temperature.

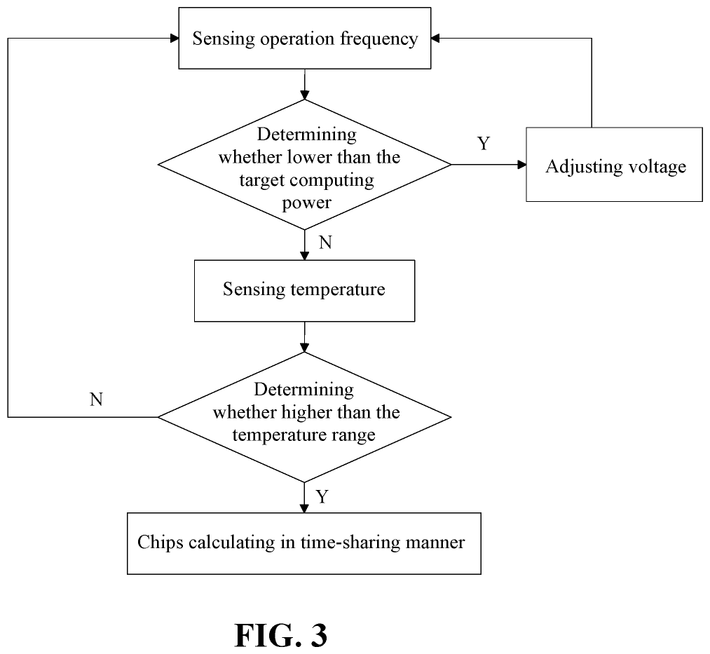

FIG. 3 is a flowchart of the operation of a movable mining machine 1 with dynamically adjustable computing power according to another embodiment of the present invention. As shown in FIG. 1 and FIG. 3, after the chip of the computing unit 10 starts to calculate the hash value, the control unit 40 senses the computing frequency of each chip synchronously, and judges whether the computing power of the computing unit is lower than the target computing power. If the hash value rate calculated per second (the number of hash values generated per second) is lower than the target computing power, the control unit 40 can immediately control the power unit 30 to increase the voltage of the chips with a lower computing frequency among the plurality of chips to optimize the computing power resources and performance. The control unit 40 controls the operation frequency of the plurality of chips (the computing unit 10 can be regarded as a whole) between 100 MHz and 2 GHz, such as but not limited to, 100-550 MHz, 550-820 MHz, 820 MHz-1 GHz, 1-1.5 GHZ, 1.5-2 GHz.

Specifically, the computing unit 10 generates heat during the calculation of the hash value, and the temperature sensor of the sensing unit 20 can sense the temperature of the computing unit 10. As the computing frequency of the chip increases, the temperature of the computing unit also increases. The overly high temperature will affect the performance of the chips. When the hash value calculated by the computing power unit 10 reaches the target computing power, and the temperature of the computing unit 10 exceeds an upper limit of the temperature range, the control unit 40 can control the power unit 30 to provide power to different chips in the computing unit 10 in a time-sharing manner, so that the plurality of chips calculates the hash value in a time-sharing manner. The temperature range is from 25° ° C. to 90° C., such as but not limited to, 25° C., 40° C., 50° C., 60° C., 70° C., 80° C., 90° C.

Specifically, the computing unit 10 includes the n-th chip and the (n+1)th chip (n>1), and the control unit 40 can switch the power delivered by the power unit 30 to the n-th chip and the (n+1)th chip, so that the n-th chip and the (n+1)th chip take turns to calculate the hash value. The chips of the computing unit 10 are dynamically and intelligently controlled by the control unit 40 based on the overall operation and temperature range, and the chips with higher computing efficiency or chips with lower computing frequency are configured to calculate the hash value at the same time or in a time-sharing and labor-divided manner, so that the mining machine with dynamically adjustable computing power of the present invention can achieve the optimal computing efficiency and power consumption performance.

It is worth mentioning that when the power of the power unit is insufficient, the control unit 40 can immediately control the power unit 30 to reduce the power provided to the computing unit 10, or control the power unit 30 to provide power to different chips in the plurality of chips in a time-sharing manner, thereby maintaining the computing power of the computing unit 10 and prevent the mining machine from stop computing.

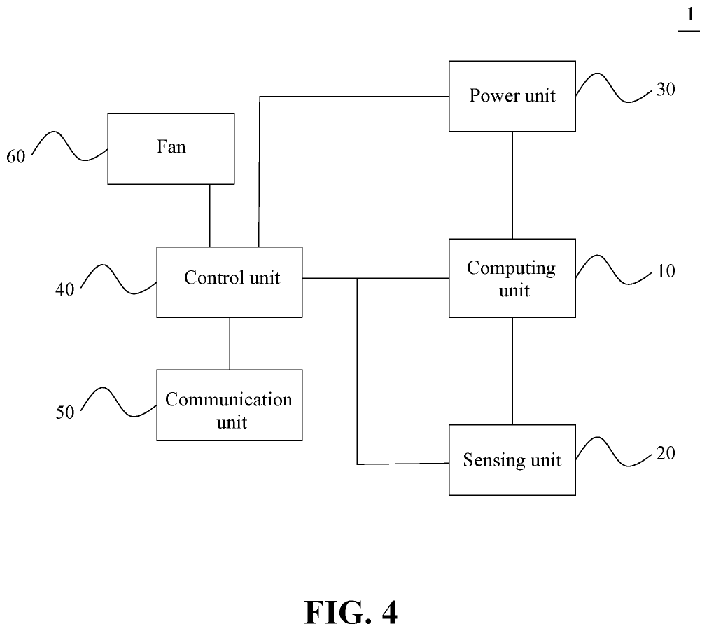

FIG. 4 is a block diagram of a movable mining machine 1 with dynamically adjustable computing power according to another embodiment of the present invention. As shown in FIG. 4, the mining machine 1 with dynamically adjustable computing power includes a computing unit 10, a sensing unit 20, a power unit 30, a control unit 40, a communication unit 50, and a fan 60; wherein the fan 60 is connected to the control unit 40 and the power unit 30. The fan 60 is disposed at a position facing the computing unit 10, and can rotate to generate airflow to lower the temperature of the computing unit 10.

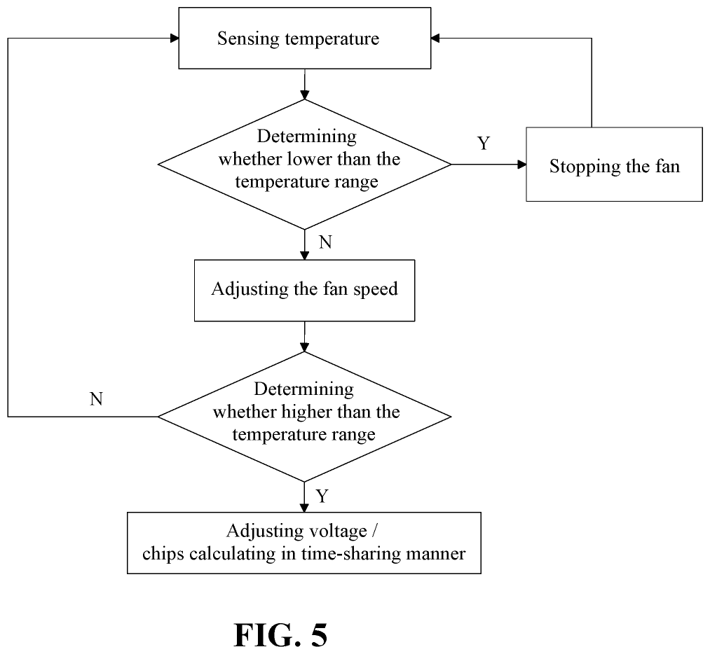

FIG. 5 is an operation flowchart of the mining machine 1 with dynamically adjustable computing power according to another embodiment of the present invention. As shown in FIGS. 4 and 5, the computing unit 10 starts to calculate the hash value, and the temperature sensor of the sensing unit 20 periodically transmits the temperature of the computing unit 10 as a whole or the temperatures of individual chips to the control unit 40. Specifically, when the temperature sensor detects that the temperature of the computing unit 10 is lower than the lower limit of the temperature range (such as but not limited to 40° C., 45° C.), the control unit 40 controls the fan 60 to stop rotating. When the temperature of the computing unit 10 is within the temperature range, the control unit 40 adjusts the rotational speed of the fan 60 according to the temperature of the computing unit 10; that is, the higher the temperature of the computing unit 10, the faster the speed of the fan 60. When the fan 60 rotates at the highest speed and the temperature of the computing unit 10 still exceeds the upper limit of the temperature range, the control unit 40 can control the power unit 30 to reduce or divide the power supplied to the chips until the temperature of the computing unit 10 falls back to the temperature range. The control unit 40 dynamically controls the fan 60 according to the temperature of the computing unit 10 and the set temperature range, which not only ensures that the computing unit 10 maintains the optimal computing power for a long time, but also saves energy.

In summary, the technical features of the movable mining machine with dynamically adjustable computing power of the present invention and its achievable technical effects are summarized as follows:

First, different calculation programs/algorithms can be used to calculate the hash value to increase the maximum computing power.

Second, the chip computing efficiency is intelligently and dynamically adjusted to optimize computing resources and performance.

Third, the intelligent dynamic control of the power unit ensures that the calculation unit maintains the optimal computing power for a long time, and prevents the chips from stopping calculation due to insufficient power.

Fourth, the chips are intelligently and dynamically controlled in the time-sharing and labor-division manner to achieve the best computing efficiency and power efficiency.

Fifth, the idle resources of computer devices can be integrated for mining.

Sixth, the overall size is small, suitable for users to carry, and can be connected to the network for computing anytime and anywhere.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A mining machine with dynamically adjustable computing power, comprising:
a computing unit, comprising a plurality of chips connected in parallel to calculate a hash value of a block;
a power unit, comprising a voltage regulator, to provide power to the computing unit and adjust the voltage sent to the plurality of chips;
a sensing unit, comprising a temperature sensor, connected to the computing unit, to sense temperatures of the plurality of chips;
a control unit, connected to the computing unit, the power unit, and the sensing unit to control the plurality of chips to calculate the hash value of the block, and control the operation frequency of the plurality of chips according to a target computing power and temperature range of the computing unit; and
a communication unit, connected to the control unit, for transmitting the hash value of the block and a verification result of the hash value through the network; wherein when the hash value calculated by any chip in the plurality of chips being verified to be correct, the control unit controlling the plurality of chips to stop calculating the hash value of the block until the communication unit receiving a next block.

2. The mining machine with dynamically adjustable computing power according to claim 1, wherein the target computing power is between 1 MH/s and 500 TH/s.

3. The mining machine with dynamically adjustable computing power according to claim 1, wherein the temperature range is from 25° C. to 90° C.

4. The mining machine with dynamically adjustable computing power according to claim 1, wherein the control unit controls the operating frequencies of the plurality of chips to be between 100 MHz and 2 GHz.

5. The mining machine with dynamically adjustable computing power according to claim 1, wherein when the computing power of the computing unit is lower than the target computing power, the control unit controls the power unit to increase the voltages of the chips with a lower computing frequency among the plurality of chips, so as to increase the computing power of the computing unit.

6. The mining machine with dynamically adjustable computing power according to claim 1, wherein when the hash value calculated by the computing unit reaches the target computing power, and the temperatures of the plurality of chips exceed an upper limit of the temperature range, the control unit controls the power unit to provide power to the plurality of chips in a time-sharing manner, so that the plurality of chips are time-sharing in calculating the hash value of the block.

7. The mining machine with dynamically adjustable computing power according to claim 1, wherein the communication unit comprises a wired module and/or a wireless module, wherein the wired module is a universal serial bus (USB) that can be connected to a computer device, and the wireless module is a Global System for Mobile Communications (GSM), Wi-Fi, or Bluetooth.

8. The mining machine with dynamically adjustable computing power according to claim 1, further comprising a fan, connected to the control unit and the power unit, and able to rotate to generate airflow to reduce the temperature of the computing unit.

9. The mining machine with dynamically adjustable computing power according to claim 8, wherein when the temperature of the computing unit is lower than a lower limit of the temperature range, the control unit controls the fan to stop rotating; when the temperature of the computing unit is within the temperature range, the control unit adjusts the rotational speed of the fan according to the temperature of the computing unit.

10. The mining machine with dynamically adjustable computing power according to claim 1, wherein when the power of the power unit is insufficient, the control unit controls the power unit to reduce the power provided to the computing unit, or controls the power unit to provide power to different chips among the plurality of chips in a time-sharing manner.
